(19) United States
(12) Patent Application Publication
(10) Pub. No.: US 2007/0251742 A1
(43) Pub. Date: Nov. 1, 2007

(54) Vehicle with hybrid power train providing part-time all-wheel drive

(76) Inventors: Herbert L. Adams III, Waterford, MI (US); Gregory A. Marsh, Ferndale, MI (US); Curt D. Gilmore, Fenton, MI (US); Robert J. Degowske, Fair Haven, MI (US)

Correspondence Address: HARNESS, DICKEY & PIERCE, P.L.C., P.O. BOX 828, BLOOMFIELD HILLS, MI, 48303, US

(21) Appl. No.: 11/415,457

(22) Filed: May 1, 2006

(51) Int. Cl. B60K 6/00; B60K 17/00; B60G 17/056

(52) U.S. Cl. 180/65.2; 180/65.5; 280/5.5; 180/338

(57) ABSTRACT

A suspension module that includes a suspension component, a pair of wheel hubs coupled to the suspension component, and an auxiliary drive system. The auxiliary drive system has a pair of drive units, each of which being configured to selectively provide drive torque to an associated one of the wheel hubs. Each drive unit includes an electric motor, a first reduction gear set and a clutch. The first reduction gear set is disposed between the motor and its wheel hub and multiplies torque output from the motor. The clutch is configured to selectively disconnect the motor from the associated wheel hub so that an output shaft of the motor is not drivingly coupled to the associated wheel hub when a rotational speed of the first portion does not exceed a rotational speed of the second portion. A method for operating a hybrid power train is also provided.

### INTRODUCTION

The present disclosure generally relates to vehicle drive trains and more particularly to a vehicle drive train having a secondary power source, such as one or more electric motors, for providing part-time all-wheel drive capability.

It is known in the art to provide an all-wheel drive vehicle drive train that provides drive torque to the front and rear wheels of a vehicle on either a full-time basis or a part-time but automatically-engaging basis. The known full-time all-wheel drive configurations typically utilize a transfer case or power transfer unit and a center differential or coupling to distribute drive torque to a front differential, which in turn distributes drive torque to the set of front wheels, and a rear differential, which in turn distributes drive torque to the set of rear wheels. The known part-time all-wheel drive configurations typically utilize a power transmitting coupling that permits a set of wheels (e.g., the rear wheels) to coast until the other set of wheels (e.g., the front set of wheels) begin to loose traction

One drawback of these all-wheel drive arrangements concerns their complexity and overall cost. Not only are the components of the all-wheel drive system relatively complex and costly to manufacture and install, the associated vehicle architecture is frequently more complex due to the common practice of vehicle manufacturers to offer vehicles with a standard two-wheel configuration and an optional all-wheel drive configuration. In this regard, it is frequently necessary to modify the vehicle fuel tank and/or relocate the spare tire of the vehicle to incorporate a conventional four-wheel drive system into a two-wheel drive vehicle.

One proposed solution involves the use of wheel hub motors. In these systems, relatively large electric motors are placed within the circumference of two or more of the vehicle wheels. As wheel hub motors are relatively large in diameter, the size of the wheel tends to be relatively large (i.e., 18 inches or greater). Consequently, wheel hub motors may not be practical as when a relatively small wheel size is employed or where packaging issues, such as the size and location of a fuel tank or the location of a spare tire, prevent a wheel hub motor from being integrated into the vehicle.

In view of the above discussion, it will be apparent that it has heretofore been impractical to offer an all-wheel drive system in a relatively inexpensive vehicle platform. Accordingly, there remains a need in the art for an improved vehicle drive train that permits an entry level-type vehicle to be equipped with all-wheel drive in a manner that is relatively inexpensive.

### SUMMARY

In one form, the present teachings provide a suspension module for a vehicle that includes at least one suspension component, a pair of wheel hubs and an auxiliary drive system. The wheel hubs are coupled to the at least one suspension component and are adapted to be mounted to a vehicle wheel. The auxiliary drive system has a pair of drive units, each of which being selectively operable for providing drive torque to an associated one of the wheel hubs. Each drive unit includes an electric motor, a first reduction gear set and a clutch. The first reduction gear set being disposed between the electric motor and the associated wheel hub and multiplies the torque that is output from the electric motor. The clutch has a first portion, which is drivingly coupled with the output shaft of the electric motor, and a second portion which is drivingly coupled with the associated one of the wheel hubs. The clutch is operable for selectively disconnecting the electric motor from the associated wheel hub so that an output shaft of the electric motor is not drivingly coupled to the associated wheel hub when a rotational speed of the first portion does not exceed a rotational speed of the second portion.

In another form, the present teachings provide a method for operating a vehicle having a hybrid power train. The hybrid power train includes a primary source of drive torque, which is configured to provide drive torque to a first set of vehicle wheels, and a secondary source of drive torque that is configured to provide drive torque to a second set of vehicle wheels. The secondary source of drive torque includes a pair of electric motors, each of which being selectively operable for transmitting rotary power to an associated wheel hub. The method includes: operating the primary source of drive torque to rotate the first set of vehicle wheels; and decoupling each electric motor from its associated wheel hub if the electric motors are not being operated to drive the associated wheel hubs.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic illustration of an exemplary vehicle having a hybrid power train constructed in accordance with the teachings of the present disclosure;

FIG. 2 is a perspective view of a portion of the vehicle of FIG. 1 illustrating the hybrid power train in more detail;

FIG. 3 is a longitudinal section view of a portion of the hybrid power train;

FIG. 4 is an enlarged portion of FIG. 3 illustrating the clutch in more detail;

FIG. 5 is a schematic illustration in flow chart form of a method for operating a hybrid power train in accordance with the teachings of the present disclosure;

FIG. 6 is a perspective view of a portion of a vehicle having another hybrid power train constructed in accordance with the teachings of the present disclosure; and

FIG. 7 is a perspective view of a portion of a vehicle having yet another hybrid power train constructed in accordance with the teachings of the present disclosure.

### DETAILED DESCRIPTION OF THE VARIOUS EMBODIMENTS

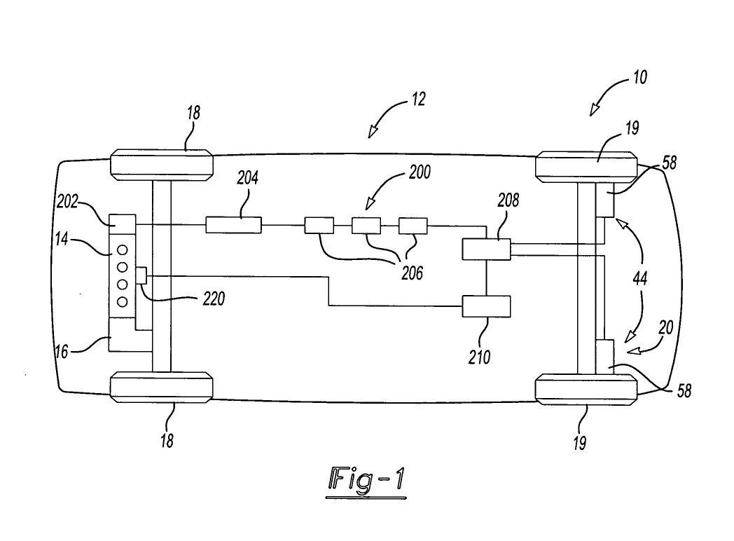

With reference to FIG. 1 of the drawings, a vehicle constructed in accordance with the teachings of the present disclosure is generally indicated by reference numeral 10. The vehicle 10 can include a body 12 to which an engine 14, a transmission 16, a set of front wheels 18 and a rear suspension module 20 can be coupled. In the particular example provided, the engine 14 and transmission 16 cooperate to provide drive torque to the set of front wheels 18.

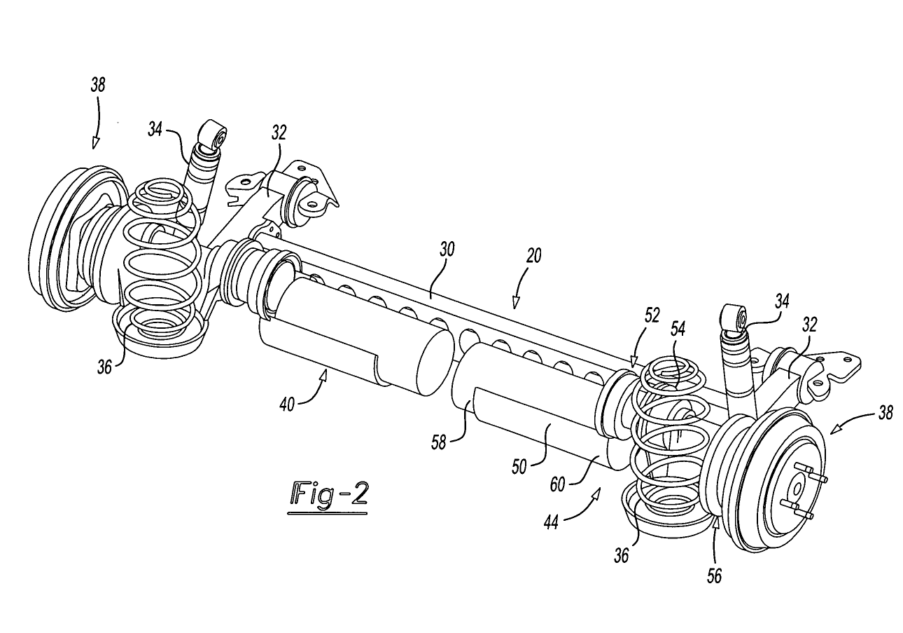

With additional reference to FIG. 2, the rear suspension module 20 can include a twist beam 30, a pair of control arms 32, a pair of shock absorbers 34, a pair of suspension springs 36, a pair of wheel hubs 38 and an auxiliary drive system 40. The control arms 32 can couple respective wheel hubs 38 to the body (not shown) of the vehicle 10, while the twist beam 30 can conventionally couple the control arms 32 to one another. The shock absorbers 34 and the suspension springs 36 can permit the rear suspension module 20 to be resiliently coupled to the vehicle body in a manner that is conventional and well known in the art.

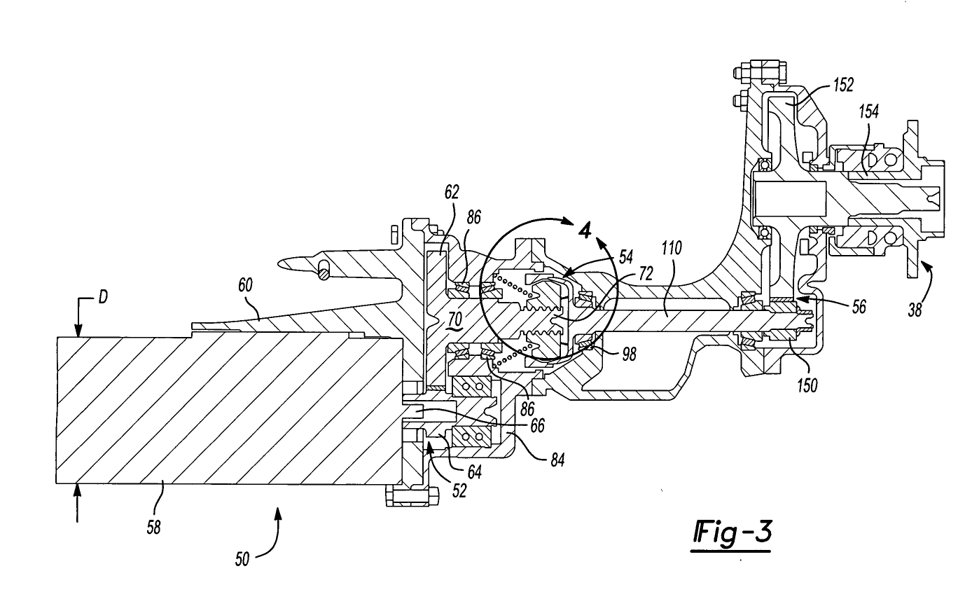

The auxiliary drive system 40 can include a pair drive units 44 and each of the drive units 44 can include a motor assembly 50, a first reduction gear set 52, a clutch 54, and a second reduction gear set 56. With reference to FIGS. 2 and 3, the motor assembly 50 of the particular example provided includes an electric motor 58 and a mounting bracket 60 that couples the electric motor 58 to the twist beam 30. The electric motor 58 can be a low voltage (i.e., <50 volts) electric motor, such as a brush-type direct current (DC) motor, and can have an outer diameter D that is less than 8 inches and more preferably, less than about 6 inches. The electric motor 58 can have a maximum sustained torque of about 15 ft.-lbs. and more preferably about 20 to about 25 ft.-lbs. for short time periods, such as at least about 120 seconds.

The electric motor 58 can output drive torque to the first reduction gear set 52, which is operable for performing a speed reduction and torque multiplication operation. The first reduction gear set 52 can have a gear ratio of about 2:1 to about 5:1. In the particular example provided, the first reduction gear set 52 utilizes a spur gear 62 having helical gear teeth that are meshingly engaged with pinion 64 that is driven by the output shaft 66 of the electric motor 58. An intermediate output shaft 70 that is coupled for rotation with the spur gear 62 can provide an input to the clutch 54. The clutch 54 can be an overrunning-type clutch that permits an associated one of the rear wheels 19 (FIG. 1) to coast when an associated one of the electric motors 58 is not operated rather than to “back drive” the electric motor 58.

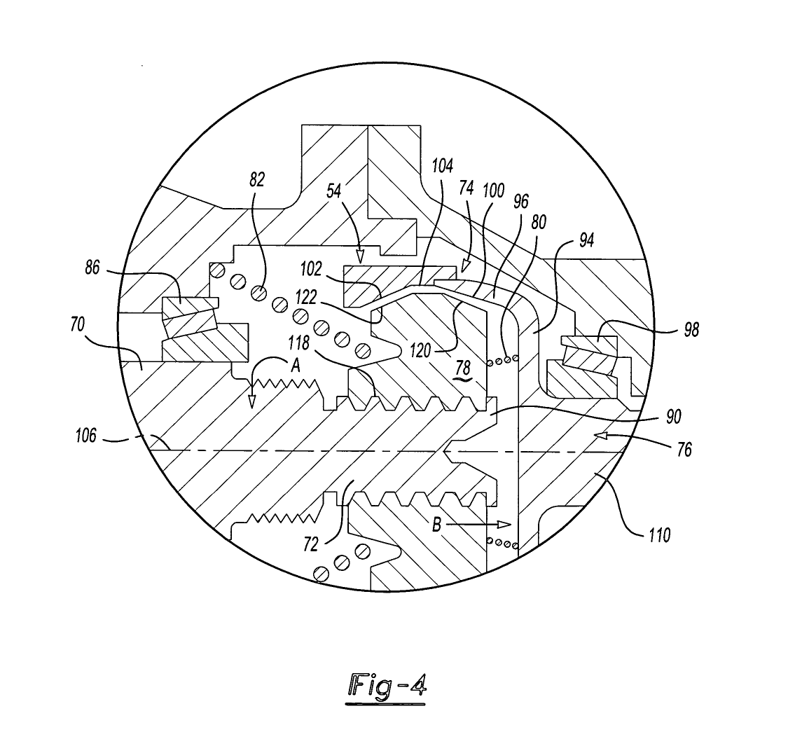

The clutch can be any appropriate type of clutch, including an overrunning clutch, a slip clutch or a clutch having an inertia disk, actuator and pressure plates (e.g., a wet clutch). Moreover, it will be appreciated that the clutch could be actuated through various mechanical, hydraulic and/or electrical means. With reference to FIG. 4, the clutch 54 can include an input shaft 72, an outer cone structure 74, an output shaft 76, an inner cone structure 78 and first and second biasing springs 80 and 82, respectively. The input shaft 72 can be supported for rotation within a clutch housing 84 by a pair of first bearings 86 and can be coupled for rotation with the intermediate output shaft 70 of the first reduction gear set 52. Optionally, the intermediate output shaft 70 and the input shaft 72 can be unitarily formed. The input shaft 72 can include a threaded portion 90 that can be formed with any appropriate thread form, such as an Acme or square thread.

The outer cone structure 74 can be generally cup-shaped with a hub portion 94 and an annular wall 96. A second bearing 98 can be employed to mount the outer cone structure 74 to the clutch housing 84 such that the annular wall 96 is rotatably disposed about the threaded portion 90 of the input shaft 72. The annular wall 96 can include first and second interfaces 100 and 102, respectively, that are disposed on opposite axial sides of a rest zone 104. The first interface 100 tapers inwardly toward the rotational center line 106 of the outer cone structure 74 as one traverses the profile of the first interface 100 from a first point, which can be located adjacent the rest zone 104, to a second point that can be located proximate the hub portion 94. Stated another way, the first interface 100 can have a shape that corresponds to the exterior surface of a frustum.

It will be appreciated that the second interface 102 can be constructed as a mirror image of the first interface 100, as is illustrated in the particular example provided. Construction in this manner permits a common clutch 54 to be used for each of the drive units 44 (FIG. 2) and as such, reduces the complexity and cost of the auxiliary drive system 40 (FIG. 2). Accordingly, a detailed discussion of the second interface 102 need not be provided herein. It will also be appreciated that the second interface 102 could be constructed somewhat differently than the first interface 100 so as to provide different locking characteristics depending upon the rotational direction of the input to the clutch 54. For example, the angle of the cone that defines the second interface 102 could be different than the angle of the cone that defines the first interface 100.

The output shaft 76 can be coupled for rotation with the outer cone structure 74. In the particular example provided, the output shaft 76 includes a cylindrically-shaped shank portion 110 that can be unitarily formed with a portion of the outer cone structure 74.

The inner cone structure 78 can have an internally threaded aperture 118 and first and second mating interfaces 120 and 122, respectively. The internally threaded aperture 118 can have a thread form that threadably engages the threaded portion 90 of the input shaft 72 so that rotation of the input shaft 72 relative to the inner cone structure 78 will cause the inner cone structure 78 to translate along a rotational axis of the input shaft 72. The first and second mating interfaces 120 and 122 can be configured to matingly engage the first and second interfaces 100 and 102, respectively. In this regard, the first mating interface 120 can have a shape that can be configured to matingly engage the first interface 100, while the second mating interface 122 can have a shape that can be configured to matingly engage the second interface 102.

The first and second biasing springs 80 and 82 cooperate to bias the inner cone structure 78 into a position relative to the rest zone 104 such that the first and second mating interfaces 120 and 122 are spaced apart from the first and second interfaces 100 and 102, respectively. The first and second biasing springs 80 and 82 can be any type of resilient device, but in the particular embodiment illustrated, are helical compression-type springs. In the particular example provided, the first biasing spring 80 is disposed between the hub portion 94 and a first axial end of the inner cone structure 78, while the second biasing spring 82 is disposed between the clutch housing 84 and a second axial end of the inner cone structure 78 that is opposite the first axial end.

In situations where the input shaft 72 is rotating at a speed that is less than a rotational speed of the outer cone structure 74, the inner cone structure 78 will be biased into a neutral position (shown in FIG. 4) by the first and second biasing springs 80 and 82 so that the first and second mating interfaces 120 and 122 are spaced apart from the first and second interfaces 100 and 102, respectively. In this condition, drive torque cannot be transmitted between the inner cone structure 78 and the outer cone structure 74. In situations where the input shaft is rotating at a speed that is greater than a rotational speed of the outer cone structure 74, the inner cone structure 78 will rotate about the threaded portion 90 of the input shaft 72 and translate toward one of the first and second interfaces 100 and 102 depending upon the direction in which the input shaft 72 is rotating. Contact between an interface and a mating interface will effectively lock the inner cone structure 78 to the outer cone structure 74 to permit torque to be transmitted therebetween.

For example, rotation of the input shaft 72 in the direction of arrow A at a rotational speed that exceeds the rotational speed of the outer cone structure 74 will cause the inner cone structure 78 to translate in the direction of arrow B so that the first mating interface 120 engages the first interface 100. Similarly, rotation of the input shaft 72 in a direction opposite that of arrow A at a rotational speed that exceeds the rotational speed of the outer cone structure 74 will cause the inner cone structure 78 to translate in a direction opposite that of arrow B so that the second mating interface 122 engages the second interface 102.

As will be appreciated, the first and second biasing springs 80 and 82 can cooperate to disengage the inner cone structure 78 from the outer cone structure 74 in situations where the inner cone structure 78 decelerates so that it has a rotational speed that is less than that of the outer cone structure 74.

With reference to FIGS. 2 and 3 the second reduction gear set 56 is operable for performing a speed reduction and torque multiplication operation and can have a gear ratio of about 2:1 to about 5:1. The second reduction gear set 56 can include a pinion 150 having helical gear teeth that are meshingly engaged with gear teeth associated with an output gear 152. The output gear 152 can be integrally formed with or mounted to a hub portion 154 of the wheel hub 38 that rotates when the associated rear wheel 19 (FIG. 1) rotates. In the particular example provided, the output gear 152 is coupled to the hub portion 154 of the wheel hub 38 via a spline connection. The hub portion 154 can otherwise be configured in a conventional and well known manner.

With renewed reference to FIG. 1, the electrical system 200 of the vehicle 10 is schematically illustrated. The electrical system 200 can include an alternator 202, a power inverter 204, one or more supplemental batteries 206, a motor controller 208 and a vehicle controller 210. The alternator 202 can be configured to provide an output with a voltage that is appropriate for providing 12 volt DC electrical power to the remainder of the electrical system 200 of the vehicle 10 as well as for charging the supplemental batteries 206. In the particular example provided, the supplemental batteries 206 are low-voltage batteries (i.e., <50 volts), such as 36 volt batteries, and can be configured in a manner so that they tolerate deep cycling (i.e., the repetitive discharge of about 80% of the maximum stored power of the supplemental batteries 206).

Given the difference between the voltage output by the alternator 202 and the voltage of the supplemental batteries 206 in the particular example provided, the power inverter 204 can be employed to change the voltage of the electrical energy produced by the alternator 202 to a voltage that is compatible with the voltage requirements of the supplemental batteries 206. In the particular example provided, the power inverter 204 performs a step-up function wherein the voltage of the electrical energy produced by the alternator 202 is stepped-up from 12 volts to 36 volts. It will be appreciated that construction of the vehicle electrical system 200 in this manner permits the remainder of the vehicle electrical system 200 that is not specifically discussed herein to be configured in a conventional and well known manner. Alternatively, the alternator 202 can be configured to provide an output with a voltage that is appropriate for charging the supplemental batteries 206. If the remainder of the vehicle electrical system 200 were to be compatible with the voltage of the electrical energy output by the alternator 202, the power inverter 204 would not be necessary. If, on the other hand, the remainder of the vehicle electrical system 200 was not compatible with the voltage of the electrical energy output by the alternator 202, an appropriate power inverter (e.g., a step-down power inverter) could be employed.

The motor controller 208 can be configured to distribute electrical power from the supplemental batteries 206 to the electric motors 58. The motor controller 208 can be any type of motor controller, but in the particular example provided the motor controller 208 is configured to control the DC voltage that is applied to the electric motors 58. In the embodiment provided, the motor controller 208 is a Model 1244 motor controller marketed by Curtis Instruments, Inc. of Mount Kisco, N.Y.

The vehicle controller 210 can be coupled to the motor controller 208 and a vehicle control module 220, which can be conventionally configured to control the operation of the engine 14 and the transmission 16. The vehicle controller 210 can receive the following inputs (e.g., from the vehicle control module 220): left front wheel speed; right front wheel speed; left rear wheel speed; right rear wheel speed; throttle position; brake activation; gear shift position; voltage of each of the supplemental batteries 206, alternator current, engine speed, vehicle speed and ignition status (on/off). The vehicle controller 210 can provide the following outputs: motor enable signal, motor direction signal, motor speed signal, state of charge signal, and power in/out signal.

The motor enable signal may be generated by the vehicle controller 210 upon the occurrence of a predetermined event or sequence of events to cause the motor controller 208 to activate the electric motors 58. For example, the vehicle controller 210 can be configured to identify those situations where one or both of the front wheels 18 of the vehicle 10 are slipping. Slipping may be identified, for example, by determining whether a difference between the wheel speeds of the front wheels 18 exceeds a predetermined differential, or by determining whether a difference between a speed of the perimeter of each front wheel and the vehicle speed exceeds a predetermined differential. Additionally or alternatively, the vehicle controller 210 can be configured to identify those situations where rapid acceleration of the vehicle is desired. For example, the vehicle controller 210 can determine if the speed of the vehicle is below a predetermined threshold and the throttle of the engine is opened significantly thereby indicating that the operator of the vehicle desires that the vehicle accelerate relatively rapidly.

Generation of the motor enable signal can also be conditioned upon the occurrence of other events or conditions, such as a speed of the vehicle 10 is less than a predetermined speed threshold (e.g., 25 miles per hour), the ignition status is on, the gear selector (not shown) is in a predetermined position (e.g., a forward gear setting or a reverse gear setting), the voltage of the supplemental batteries 206 exceeds a predetermined threshold and the vehicle brakes (not shown) have not been actuated by the vehicle operator.

The motor direction signal can be generated by the vehicle controller 210 to designate the direction in which the electric motors 58 are to turn their respective rear wheels 19. The vehicle controller 210 can determine the motor direction signal (i.e., forward or reverse) based on the position of the gear selector (not shown). The motor speed signal can be generated by the vehicle controller 210 to designate a speed at which the rear wheels 19 (or a related component, such as the output shafts of the electric motors 58) are to turn. The state of charge signal can be generated by the vehicle controller 210 to designate those situations where the supplemental batteries 206 are charged to a predetermined level. The power in/out signal can be employed to communicate information to another control system or to the vehicle operator. In the example provided, the power in/out signal is employed to light a telltale indicator (not shown) in the instrument panel (not shown) to inform the vehicle operator when electric motors 58 are activated.

The motor controller 208 can be configured such that it will not activate the electric motors 58 unless it receives the motor enable signal in addition to one or more of the motor direction signal, the motor speed signal and the state of charge signal.

It will be appreciated that once activated, the electric motors 58 will produce supplementary power that will be output to the first reduction gear set 52. If the output of the first reduction gear set 52 is rotating at a speed that is faster than that of the input of the second reduction gear set 56, power will be transmitted through the clutch 54 to the second reduction gear set 56 and ultimately to an associated one of the rear wheels 19.

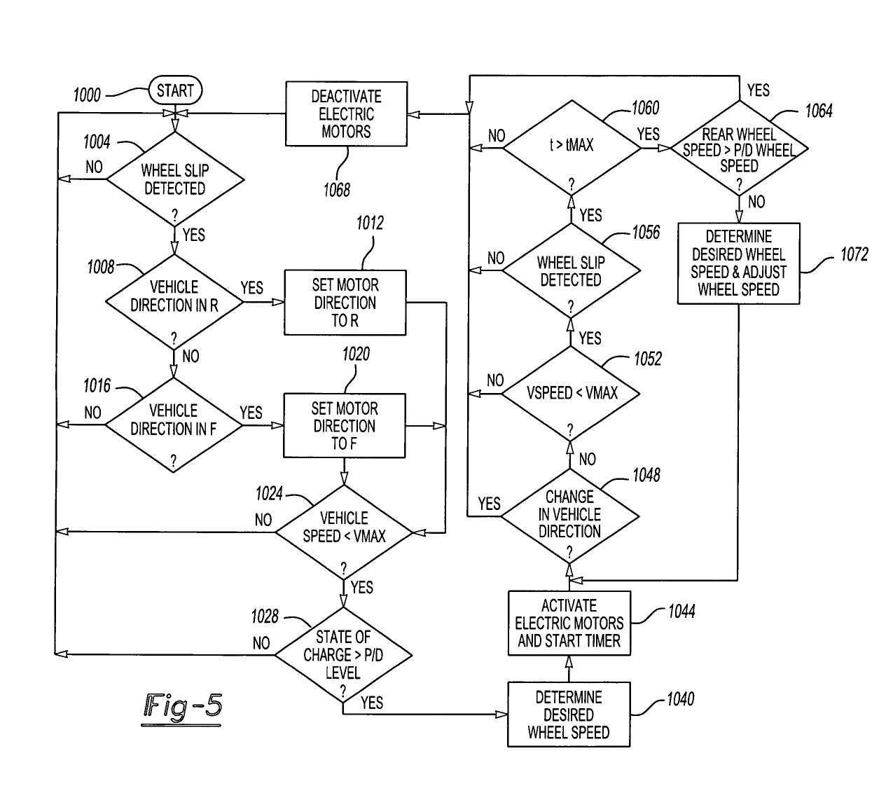

In FIG. 5, the operation of the vehicle 10 (FIG. 1) is schematically illustrated. The methodology begins at bubble 1000 and can progress to decision block 1004 where wheel slip of the front wheels 18 (FIG. 1) can be evaluated. If wheel slip is not detected in either front wheel 18 (FIG. 1), the methodology can loop back to decision block 1004. If wheel slip is detected in one or both of the front wheels 18 (FIG. 1) in decision block 1004, the methodology can proceed to decision block 1008.

In decision block 1008, the vehicle direction (i.e., the direction in which the vehicle 10 is traveling) can be evaluated. As will be appreciated, the vehicle direction can be evaluated based on numerous criteria, such as a gear shift selector position, etc. If the vehicle direction corresponds to a rearward direction, the methodology can proceed to block 1012 where the motor direction may be set to a first direction. The methodology can proceed to decision block 1024.

Returning to decision block 1008, if the vehicle direction does not correspond to a rearward direction, the methodology can proceed to decision block 1016. If the vehicle direction does not correspond to a forward direction, the methodology can loop back to decision block 1004. If the vehicle direction does correspond to a forward direction, the methodology can proceed to block 1020 where the motor direction can be set to a second direction. The methodology can proceed to decision block 1024.

In decision block 1024, the speed of the vehicle 10 can be evaluated. As will be appreciated, the vehicle speed can be evaluated based on numerous criteria, such as a vehicle speed measured or calculated by the vehicle controller 210 (FIG. 1) or by the vehicle control module 220 and transmitted to the vehicle controller 210. If the vehicle speed is greater than a predetermined maximum speed, such as 25 miles per hour, the methodology can loop back to decision block 1004. If the vehicle speed is not greater than the predetermined maximum speed, the methodology can proceed to decision block 1028.

In decision block 1028, the charge level of the supplemental batteries 206 (FIG. 1) can be compared with a predetermined charge level. If the charge level of the supplemental batteries does not exceed the predetermined charge level, the methodology can loop back to decision block 1004. If the charge level of the supplemental batteries exceeds the predetermined charge level, the methodology can proceed to block 1040.

In block 1040, the methodology can determine a desired wheel speed. The methodology can proceed to block 1044.

In block 1044, the methodology can activate the electric motors 58 (FIG. 1) to drive the rear wheels 19 (FIG. 1) and can activate a timer that records the duration with which the electric motors 58 (FIG. 1) have been activated. Activation of the electric motors 58 (FIG. 1) can be responsive to the receipt of various signals by the motor controller 208 (FIG. 1), such as the motor enable signal, the motor direction signal, the motor speed signal, and the power in/out signal. The methodology can proceed to decision block 1048.

In decision block 1048, the methodology can evaluate the vehicle direction. If a change has occurred in the vehicle direction, the methodology can proceed to block 1068 where the electric motors 58 (FIG. 1) are deactivated. The methodology can loop back to decision block 1004. Returning to decision block 1048, if no change has occurred in the vehicle direction, the methodology can proceed to decision block 1052.

In decision block 1052, the methodology can evaluate the vehicle speed. If the vehicle speed is greater than or equal to the predetermined maximum speed, the methodology can proceed to block 1068. If the vehicle speed is less than the predetermined maximum speed, the methodology can proceed to decision block 1056.

In decision block 1056, the methodology can determine if either of the front wheels 18 (FIG. 1) is slipping. If neither front wheel is slipping, the methodology can proceed to block 1068. If either front wheel is slipping, the methodology can proceed to decision block 1060.

In decision block 1060, the methodology can compare the present value of the timer with a predetermined maximum timer value, such as 60 seconds. If the present value of the timer exceeds the predetermined maximum timer value, the methodology can proceed to block 1068. If the present value of the timer does not exceed the predetermined maximum timer value, the methodology can proceed to decision block 1064.

In decision block 1064, the methodology can determine if the speed of either of the rear wheels 19 (FIG. 1) exceeds a predetermined wheel speed. If the speed of either rear wheel exceeds the predetermined wheel speed, the methodology can proceed to block 1068. If the speed of both rear wheels does not exceed the predetermined wheel speed, the methodology can proceed to block 1072 where a new value of the desired wheel speed is determined and employed to adjust the wheel speed of the rear wheels as necessary.

As the electric motors 58 (FIG. 1) are wired in parallel and are controlled via the DC voltage output by the motor controller 208 (FIG. 1) in the example provided, the electric motors 58 (FIG. 1) will function in a manner that is similar to a mechanical limited-slip differential. More specifically, if one of the rear wheels 19 (FIG. 1) looses traction the current that is output by the motor controller 208 (FIG. 1) will decrease but as no change will occur in the DC voltage provided to the other electric motor 58 (FIG. 1), there will be little impact on the performance/operation of the electric motor 58 (FIG. 1) that is associated with the non-slipping rear wheel 19 (FIG. 1). It will be apparent to those of ordinary skill in the art that in the event that one or both of the rear wheels 19 (FIG. 1) loose traction, power to the associated electric motor 58 (FIG. 1) could be interrupted (to one or both of the electric motors 58 (FIG. 1)) to permit the rear wheel or wheels 19 (FIG. 1) to gain traction.

Those of ordinary skill in the art will also appreciate that the electric motors 58 (FIG. 1) may be controlled via a single motor controller 208 (FIG. 1) in various other ways. For example, the motor controller may be configured to control the current that is delivered to the electric motors 58 (FIG. 1). Also, the electric motors 58 (FIG. 1) could be wired in series with one another and controlled by a single motor controller that is configured to control the DC voltage or current that is delivered to the electric motors. Those of ordinary skill in the art will also appreciate that the electric motors 58 (FIG. 1) need not be wired in parallel but could, in the alternative, be controlled by separate motor controllers 208. Configuration in this manner can permit each of the motor controllers 208 to independently identify wheel slip and to control their respective electric motors 58 (FIG. 1) in an appropriate manner.

It will be appreciated that the rear suspension module 20 (FIG. 1) is configured in a modular manner that is readily interchangeable with a standard (i.e., non-powered) rear suspension module. In this regard, the rear suspension module (20) and a standard rear suspension module can be coupled to the vehicle in a common manner. Accordingly, the configuration of the rear suspension module 20 (FIG. 1) is advantageous in that four-wheel drive capabilities can be provided in a relatively inexpensive and efficient manner.

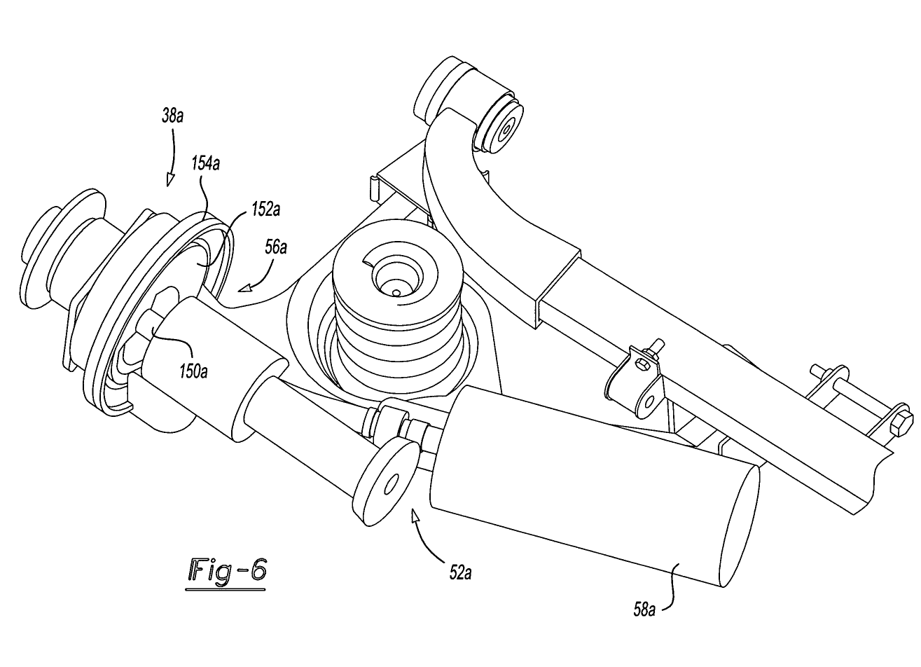

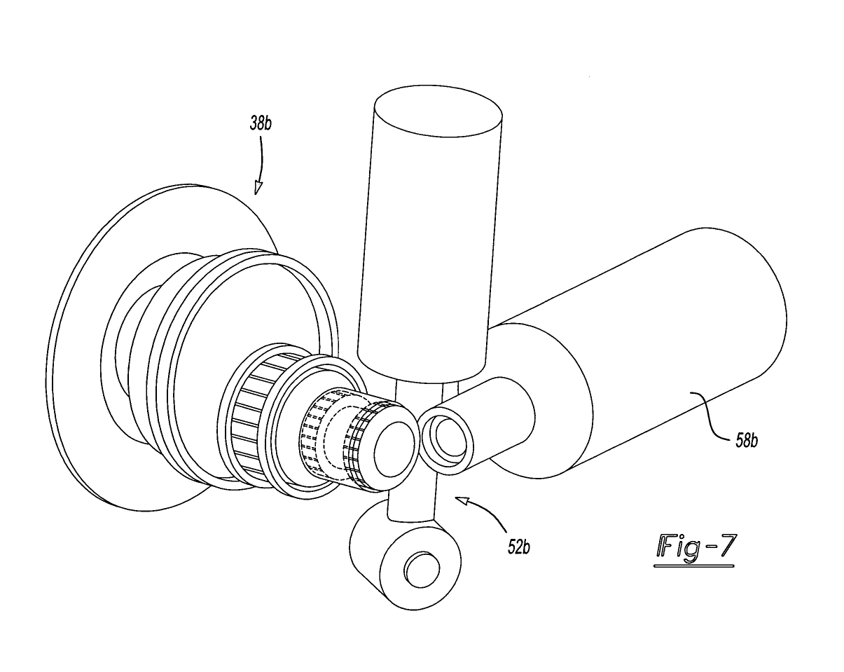

While the rear suspension module 20 (FIG. 1) has been illustrated and described herein as including an auxiliary drive system 40 (FIG. 1) having first and second gear reductions 52 and 56 (FIG. 2) whose axes are parallel with the axis of the output shaft of an associated one of the electric motors 58 (FIG. 1), those of ordinary skill in the art will appreciate that the disclosure, in its broadest aspects, could be configured somewhat differently. For example, one or more spur gear or bevel gear arrangements may be employed to produce one or more reductions in gear ratio between the output of the electric motors 58 (FIG. 1) and the output gear 152 (FIG. 3) that is associated with the hub portion 154 of the wheel hub 38. FIG. 6 illustrates an example wherein the first reduction gear set 52a utilizes a bevel gear arrangement and the second reduction gear set 56a utilizes a helical spur gear arrangement. The second reduction gear set 56a includes a pinion 150a having helical gear teeth that are meshingly engaged with internal gear teeth formed on an output gear 152a that is fixedly coupled to the hub portion 154a of the wheel hub 38a. In this example, the electric motor 58a is disposed at an angle (i.e., not parallel or perpendicular) to the rotational axis of the wheel hub 38a. FIG. 7 illustrates another example wherein the first reduction gear set 52b utilizes a bevel gearing arrangement but the electric motor 58b is disposed generally perpendicular to the rotational axis of the wheel hub 38b.

While specific examples have been described in the specification and illustrated in the drawings, it will be understood by those of ordinary skill in the art that various changes may be made and equivalents may be substituted for elements thereof without departing from the scope of the present disclosure as defined in the claims. For example, it will be appreciated from this disclosure that the electric motor 58 could be an AC induction motor and/or that the clutch 54 could be another type of clutch, such as a slip clutch, or could be deleted altogether. Furthermore, the mixing and matching of features, elements and/or functions between various examples is expressly contemplated herein so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out this invention, but that the scope of the present disclosure will include any embodiments falling within the foregoing description and the appended claims.

What is claimed is:

1 . A suspension module for a vehicle comprising:
at least one suspension component;
a pair of wheel hubs that are coupled to the at least one suspension component, each wheel hub being adapted to be mounted to a vehicle wheel; and
an auxiliary drive system having a pair of drive units, each drive unit being selectively operable for providing drive torque to an associated one of the wheel hubs, each drive unit including an electric motor, a first reduction gear set and a clutch, the first reduction gear set being disposed between the electric motor and the associated wheel hub and multiplying torque output from the electric motor, the clutch having a first portion, which is drivingly coupled with the output shaft of the electric motor, and a second portion which is drivingly coupled with the associated one of the wheel hubs, the clutch being operable for selectively disconnecting the electric motor from the associated wheel hub so that an output shaft of the electric motor is not drivingly coupled to the associated wheel hub when a rotational speed of the first portion does not exceed a rotational speed of the second portion.

2. The suspension module of claim 1, wherein each auxiliary drive system further includes a second reduction gear set disposed between the electric motor and the associated wheel hub.

3. The suspension module of claim 2, wherein the second reduction gear set includes an input gear, which is coupled for rotation with the second portion of the clutch, and a output gear which is coupled for rotation with the wheel hub.

4. The suspension module of claim 1, wherein the electric motor has an outer diameter that is less than about 8 inches.

5. The suspension module of claim 4, wherein the outer diameter is less than about 6 inches.

6. The suspension module of claim 1, wherein a maximum sustained torque of an output of the electric motor is less than about 25 ft-lbs.

7. The suspension module of claim 1, wherein the first portion of the clutch is an inner cone structure and the second portion of the clutch is an outer cone structure and wherein the inner cone structure translates to engage the outer cone structure when the rotational speed of the inner cone structure exceeds the rotational speed of the outer cone structure.

8. The suspension module of claim 7, wherein the outer cone structure includes first and second interfaces, wherein the inner cone structure includes first and second mating interfaces, wherein the first mating interface engages the first interface when the inner and outer cone structures rotate in a first direction and wherein the second mating interface engages the second interface when the inner and outer cone structures rotate in a second direction opposite the first direction.

9. The suspension module of claim 8, wherein a rest area is formed on the outer cone structure between the first and second interfaces, the rest area being operable for axially spacing the first and second interfaces apart from one another, and wherein the inner cone structure is biased into the rest area.

10. The suspension module of claim 1, further comprising a controller coupled to the drive units, the controller being adapted to distribute electric power from a power source to the electric motors.

11. The suspension module of claim 10, wherein the controller includes a motor controller and a vehicle controller, the motor controller being operable for distributing electric power to the electric motors in response to a motor enable signal and a motor speed signal, the vehicle controller being adapted to generate the motor enable signal and the motor speed signal in response to a plurality of vehicle characteristics including vehicle speed.

12. The suspension module of claim 11, wherein a single motor controller is employed to distribute electric power to the electric motors.

13. The suspension system of claim 1, wherein the at least one suspension component is a twist-beam.

14. A suspension module for a vehicle comprising:
at least one suspension component;
a pair of wheel hubs that are coupled to the at least one suspension component, each wheel hub being adapted to be mounted to a vehicle wheel;
an auxiliary drive system having a pair of drive units, each drive unit being selectively operable for providing drive torque to an associated one of the wheel hubs, each drive unit including an electric motor, a first reduction gear set, a clutch and a second reduction gear set, the electric motor providing an input to the first reduction gear set, the second reduction gear set having an output that is drivingly coupled to the associated one of the wheel hubs, the clutch being operable in a first condition for transmitting power between the first reduction gear set and the second reduction gear set, the clutch also being operable in a second condition which inhibits power transmission between the first reduction gear set and the second reduction gear set;
a vehicle controller that generates a motor speed signal and a motor enable signal in response to a predetermined vehicle condition; and
a motor controller that is configured to operate the electric motors in response to the motor enable signal and the motor speed signal.

15. The suspension module of claim 14, wherein the clutch is operated in the second condition when an output of the first reduction gear set rotates at a rotational velocity that is slower than a rotational velocity of an input of the second reduction gear set.

16. The suspension module of claim 14, wherein the predetermined vehicle condition includes a wheel slip condition.

17. The suspension module of claim 14, wherein the predetermined vehicle condition includes a request for rapid acceleration.

18. A method for operating a vehicle having a hybrid power train, the hybrid power train including a primary source of drive torque, which is configured to provide drive torque to a first set of vehicle wheels, and a secondary source of drive torque that is configured to provide drive torque to a second set of vehicle wheels, the secondary source of drive torque including a pair of electric motors, each of the electric motors being selectively operable for transmitting rotary power to an associated wheel hub, the method comprising:
operating the primary source of drive torque to rotate the first set of vehicle wheels; and
decoupling each electric motor from its associated wheel hub if the electric motors are not being operated to drive the associated wheel hubs.

19. The method of claim 18, wherein a clutch is employed between each electric motor and its associated wheel hub to selectively decouple the electric motor from its associated wheel hub.

20. The method of claim 19, wherein the clutch is disposed between an output of a first reduction gear set and an input of a second reduction gear set.
